(19) United States
(12) Patent Application Publication
(10) Pub. No.: US 2013/0055319 A1
(43) Pub. Date: Feb. 28, 2013

(54) APPARATUS AND METHOD FOR SHARING TELEVISION BROADCASTING

(71) Applicants: Jeong-Cheol LEE, Gyeonggi-do (KR); Tae-Keun OH, Seoul (KR); Kyung-Chun MOON, Gyeonggi-do (KR); Kwang-Jeung LEE, Gyeonggi-do (KR)

(72) Inventors: Jeong-Cheol LEE, Gyeonggi-do (KR); Tae-Keun OH, Seoul (KR); Kyung-Chun MOON, Gyeonggi-do (KR); Kwang-Jeung LEE, Gyeonggi-do (KR)

(73) Assignee: SAMSUNG ELECTRONICS CO., LTD., Gyeonggi-Do (KR)

(21) Appl. No.: 13/589,833

(22) Filed: Aug. 20, 2012

(30) Foreign Application Priority Data
Aug. 30, 2011 (KR) 10-2011-0087056

(51) Int. Cl. H04N 21/61

(52) U.S. Cl. 725/74

(57) ABSTRACT

An apparatus and method for sharing television broadcasting are provided. The method includes, in a first portable terminal, connecting to a wireless network, and sending a TV broadcasting request to a TV module, for the first portable terminal to be granted a master function of switching a TV channel, receiving a password input request from the TV module, and transmitting a password to the TV module, in the first portable terminal, receiving the TV broadcasting from the TV module through the wireless network, and, in at least one or more additional portable terminals, receiving the TV broadcasting from the TV module through the wireless network, and sharing the TV broadcasting with the first portable terminal.

### CLAIM OF PRIORITY

This application claims priority under 35 U.S.C. §119(a) from Korean Patent Application No. 10-2011-0087056 filed in the Korean Intellectual Property Office on Aug. 30, 2011, which is hereby incorporated by reference in its entirety.

### BACKGROUND OF THE INVENTION

1. Field of the Invention

The present invention relates to Television (TV) broadcasting. More particularly, the present invention relates to an apparatus and method for sharing the TV broadcasting unknown heretofore.

2. Description of the Related Art

Generally, in a conventional channel sharing method, where a plurality of users who share a TV channel all are master users, anyone of them can switch the TV channel. For instance, the moment one user who is watching on one of several TVs displayed at a retail store manipulates a TV channel with a remote controller, channels of all the TVs displayed within the store are switched. At this time, the channels of all the TVs are also again switched if another user manipulates the TV channel with the remote controller. As a result, many users are placed in a state in which they cannot view desired TV channels.

As described above, in the conventional channel sharing method, it is unclear as to who controls the channel selection, and a TV channel can often be switched by any one of the users, making normal viewing either chaotic or virtually impossible from the multiple channel selections. Also, in a system watching a TV through an external module, there is a problem that, if a plurality of users share a TV channel through the external module, confusion is caused because all the users have channel control.

### SUMMARY OF THE INVENTION

An exemplary aspect of the present invention is to provide a television (TV) broadcasting sharing apparatus and method for, when a plurality of users share a TV channel, the TV channel is shared under the control of a master, thereby enabling the plurality of users to share the TV channel efficiently.

The above exemplary aspects are achieved by providing an apparatus and method for sharing television broadcasting as disclosed and claimed herein.

According to one exemplary aspect of the present invention, a method for sharing TV broadcasting is provided. The method preferably includes, in a first portable terminal the steps of connecting to a wireless network, and sending a TV broadcasting request to a TV module so the first portable terminal is granted a “master function” of switching a TV channel, receiving a password input request from the TV module, and transmitting a password to the TV module; in the first portable terminal, receiving the TV broadcasting from the TV module through the wireless network, and, in at least a 2nd portable terminal, receiving the TV broadcasting from the TV module through the wireless network, and sharing the TV broadcasting with the first portable terminal

According to another exemplary aspect of the present invention, a system for sharing Television (TV) broadcasting among a plurality of portable terminals comprises:

a TV module that transmits TV broadcasts over a wireless network compatible with the plurality of portable terminals;

a first portable terminal comprising:

a broadcasting unit that couples with the wireless network and sends a TV broadcasting request to a TV module, and receives the TV broadcast from the TV module through the wireless network;

a communication unit that requests the TV module grant to the first portable terminal a master function of switching a TV channel of the received TV broadcast, receives in response to the request a password input request from the TV module, and transmits a password to the TV module; and

one or more additional portable terminals respectively comprising broadcasting units that transmit over the wireless network to a request to receive the TV broadcast from the TV module through the wireless network, and share receipt of the TV broadcast with the first portable terminal

According to another exemplary aspect of the present invention, an apparatus for sharing TV broadcasting preferably includes a broadcasting module of a first portable terminal, a communication module of the first portable terminal, and broadcasting modules of at least one or more 2nd (i.e. additional) portable terminals. The broadcasting module of the first portable terminal connects to a wireless network, sends a TV broadcasting request to a TV module, and receives the TV broadcasting from the TV module through the wireless network. For the first portable terminal to be granted a master function of switching a TV channel, the communication module of the first portable terminal receives a password input request from the TV module, and transmits a password to the TV module. The broadcasting modules of at least one or more additional portable terminals receive the TV broadcasting from the TV module through the wireless network, and share the TV broadcasting with the first portable terminal However, only the first portable terminal has the master function of switching a TV channel, unless it is desired to grant the master function to another portable terminal.

### BRIEF DESCRIPTION OF THE DRAWINGS

The above and other exemplary objects, features and advantages of the APPARATUS AND METHOD FOR SHARING TELEVISION BROADCASTING according to the present invention will become more apparent to a person of ordinary skill in the art from the following detailed description when taken in conjunction with the accompanying drawings in which:

FIG. 1 is a block diagram illustrating a construction of a portable terminal in a television (TV) channel sharing apparatus according to an exemplary embodiment of the present invention;

FIG. 2 is a block diagram illustrating a construction of a TV module in a TV channel sharing apparatus according to an exemplary embodiment of the present invention;

FIG. 3 is a diagram illustrating a process of receiving a TV signal in a portable terminal in a TV broadcasting sharing method according to an exemplary embodiment of the present invention;

FIG. 4 is a flowchart illustrating a process of granting a first portable terminal a master control function in a TV broadcasting sharing method according to an exemplary embodiment of the present invention;

FIG. 5 is a flowchart illustrating a process of receiving TV broadcasting in a 2nd portable terminal in a TV channel sharing method according to an exemplary embodiment of the present invention;

FIG. 6 is a flowchart illustrating a process of, as a portable terminal granted a master function terminates broadcasting reception, newly granting the portable terminal the master function in a TV broadcasting sharing method according to an exemplary embodiment of the present invention; and

FIG. 7 is a diagram illustrating that, in a state where a first portable terminal is granted a master function, one or more additional portable terminals can be granted the master function in a TV channel sharing method according to an exemplary embodiment of the present invention.

### DETAILED DESCRIPTION

Preferred exemplary embodiments of the present invention will now be described herein below with reference to the accompanying drawings. In the following description, well-known functions or constructions may not be described in detail when their inclusion would obscure appreciation of the present invention by a person of ordinary skill in the art with unnecessary detail about such well-known functions or constructions. Also, parts performing like function and operations are denoted by the same symbols throughout the drawings. In addition, under the broadest reasonable interpretation, all of the terms used herein and in the claims are to be construed as being statutory subject matter that is in compliance with the machine-or-transformation test.

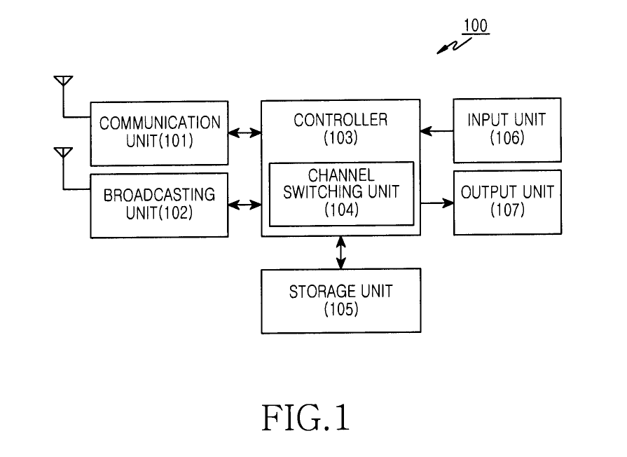

FIG. 1 is a block diagram illustrating an exemplary construction of a portable terminal 100 in a TV channel sharing apparatus according to an exemplary embodiment of the present invention.

As illustrated in FIG. 1, the portable terminal 100 preferably include a communication unit 101, a broadcasting unit 102, a controller 103, a channel switching unit 104, a storage unit 105, an input unit 106, and an output unit 107.

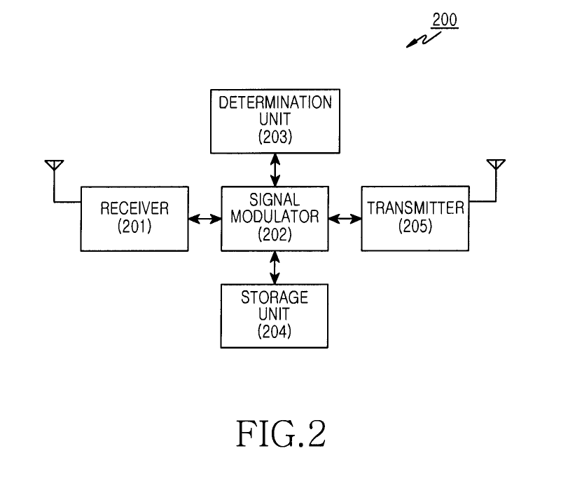

The communication unit 101 processes a signal transmitted/received through an antenna for voice and data communication. For instance, the portable terminal that is to be granted a master function of switching a TV channel according to the presently claimed invention utilizes the communication unit 101 to receives a password input request from a TV module (such as shown in FIG. 2), and transmits a password to the TV module.

The broadcasting unit 102 receives TV broadcasting from the TV module. For instance, a broadcasting unit 102 of a first portable terminal connects to a wireless network, sends a TV broadcasting request to the TV module, and receives TV broadcasting from the TV module through the wireless network, and a broadcasting unit 102 of a an additional portable terminal that receives the TV broadcasting from the TV module through the wireless network, and shares the TV broadcasting with the first portable terminal

The controller 103 controls the general operation of the portable terminal. The channel switching unit 104 can be included in the controller 103. For instance, a channel switching unit 104 of the 2nd portable terminal switches a TV channel of the 2nd portable terminal that is sharing the same TV broadcasting with the first portable terminal

The storage unit 105, which is a non-transitory machine readable medium stores a program for controlling an operation of the portable terminal, and stores data generated during the execution of the program.

The input unit 106 provides input data generated by user's selection to the controller 103.

Under the control of the controller 103, the output unit 107 displays status information of the portable terminal, menu screen and story information. For example, the output unit 107 is composed of a touch screen, and thus could constitute both the input and output units.

In the aforementioned construction, the controller 103, which includes hardware such as a processor or microprocessor, can be configured to perform the general functions of the portable terminal In the present invention, these are separately constructed and shown in order to distinguish and describe respective functions. Thus, when the claims are practiced, a product of same can be constructed so that the controller 103 can process all of the functions of the portable terminal, or can be constructed so that the controller 103 can process only some of the functions.

FIG. 2 is a block diagram illustrating a construction of a TV module 200 in a TV channel sharing apparatus according to an exemplary embodiment of the present invention.

As illustrated in the example of FIG. 2, the TV module 200 preferably includes a receiver 201, a signal modulator 202, a determination unit 203, a storage unit 204, and a transmitter 205.

The receiver 201 receives a broadcasting signal from a broadcasting station. The number of TV channels that a first and one or more additional portable terminals can simultaneously receive is in proportion to the number of receivers built in the TV module. In other words, the number of TV channels that a plurality of portable terminals can simultaneously receive is determined according to a quantity of receivers. For example, if the quantity of receivers arranged in or coupled with the TV module is four, the number of TV channels that the plurality of portable terminals can simultaneously receive is maximum four in this particular example. The maximum four channels in this particular example that the first and 2nd portable terminals can simultaneously access and view four channels, or can simultaneously view three channels excepting one. Likewise, the first and 2nd portable terminals can simultaneously view two channels excepting two, or one channel excepting three. The artisan understands that the presently claimed invention is not limited to four channels, a quantity provided for explanatory purposes.

The signal modulator 202 modulates a broadcasting signal forwarded from the receiver 201 into a wireless network signal. Here, the wireless network signal can be a Wireless Fidelity (WiFi) or Bluetooth signal, just to name two non-limiting possibilities, as other types of networks can be used. In detail, the receiver 201 receives a TV signal from the broadcasting station, and the signal modulator 202 receives the TV signal forwarded from the receiver 201 and modulates the TV signal into a wireless network signal.

The determination unit 203, which includes hardware such a processor or microprocessor, determines if the first portable terminal is receiving TV broadcasting. If it is determined that the first portable terminal is not receiving the TV broadcasting, the determination unit 203 requests the 2nd portable terminals to transmit passwords to the TV module in order to grant a master function to the 2nd portable terminals.

Also, if the first portable terminal terminates TV broadcasting reception, the determination unit 203 determines whether the 2nd portable terminals are sharing TV broadcasting with the first portable terminal If it is determined that the 2nd portable terminals are sharing the TV broadcasting, the determination unit 203 grants a master function to any one of the 2nd portable terminals. Here, the master function is granted to the 2nd portable terminal uppermost sharing the TV broadcasting, among the 2nd portable terminals. For example, assuming that there are portable terminals A, B, and C, and the portable terminals acquire the authority to share the TV broadcasting in the order of A→B→C, the portable terminal A is the terminal uppermost sharing the TV broadcasting.

The storage unit 204 receives passwords from the first and 2nd portable terminals, and preferably stores the passwords.

With continued reference to FIG. 2, the transmitter 205 transmits TV broadcasting to broadcasting units of the first and 2nd portable terminals through a wireless network. In a case where the first portable terminal is receiving the TV broadcasting, the transmitter 205 transmits the TV broadcasting to the 2nd portable terminals through the wireless network.

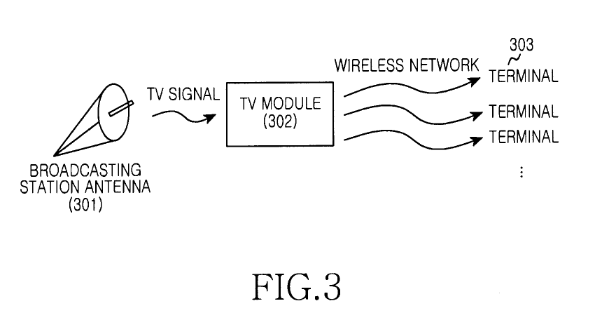

FIG. 3 is a diagram illustrating exemplary operation a process of receiving a TV signal in a portable terminal in a TV broadcasting sharing method according to an exemplary embodiment of the present invention.

As illustrated in FIG. 3, when a TV signal is propagated through a broadcasting station antenna 301, a TV module 302 receives forwarding of the TV signal and modulates the TV signal into a wireless network signal, and transmits, by the modulated wireless network signal, TV broadcasting to portable terminals 303 having requested the TV broadcasting.

As described above, a receiver of the TV module 302 receives a TV signal propagated from the broadcasting station antenna 301. Next, a signal modulator of the TV module 302 receives forwarding of the TV signal and modulates the TV signal into a wireless network signal that is a different protocol than was used to receive the TV signals. Next, a transmitter of the TV module 302 transmits the modulated wireless network signal to the portable terminals 303. Accordingly, the portable terminals 303 can receive TV broadcasting via a different protocol used to transmit the TV signal from the broadcasting station to the TV module.

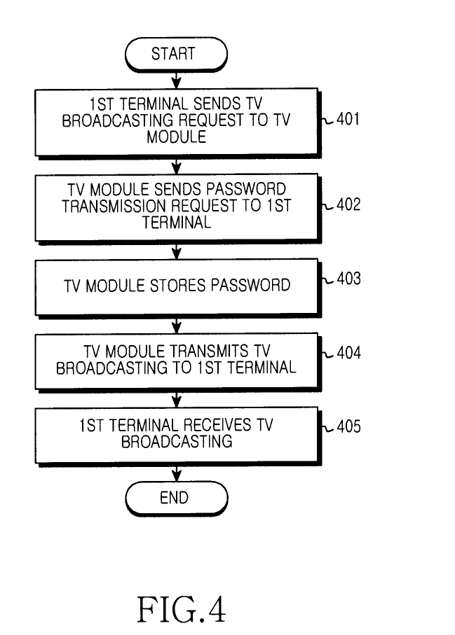

FIG. 4 is a flowchart illustrating exemplary operation of a process of granting a first portable terminal a master function in a TV broadcasting sharing method according to an exemplary embodiment of the present invention. Again, a master function can be interpreted to mean master control of functions like changing channels, volume control, etc.

As illustrated in FIG. 4, in step 401, a first portable terminal connects to a wireless network, and sends a TV broadcasting request to a TV module through the wireless network.

In step 402, the TV module receiving the TV broadcasting request sends a password transmission request to the first portable terminal so as to determine whether to grant the first portable terminal a master function of switching a TV channel according to the present invention.

Next, the first portable terminal receiving the password transmission request receives a password input from a user and transmits the password to the TV module. At step 403, the TV module stores the received password. At the same time of storing the password, the TV module grants the first portable terminal the master function of switching the TV channel, and may grant other master functions. In other words, the first portable terminal can switch a TV channel that the first portable terminal is receiving itself only, and other portable terminals cannot switch the TV channel that the first portable terminal is receiving. Accordingly, the TV channel can be more efficiently controlled than known heretofore.

With reference to FIG. 4, in step 404, the TV module transmits TV broadcasting to the first portable terminal In step 405, the first portable terminal receives the TV broadcasting from the TV module. Next, the process of granting the master function to the first portable terminal is terminated.

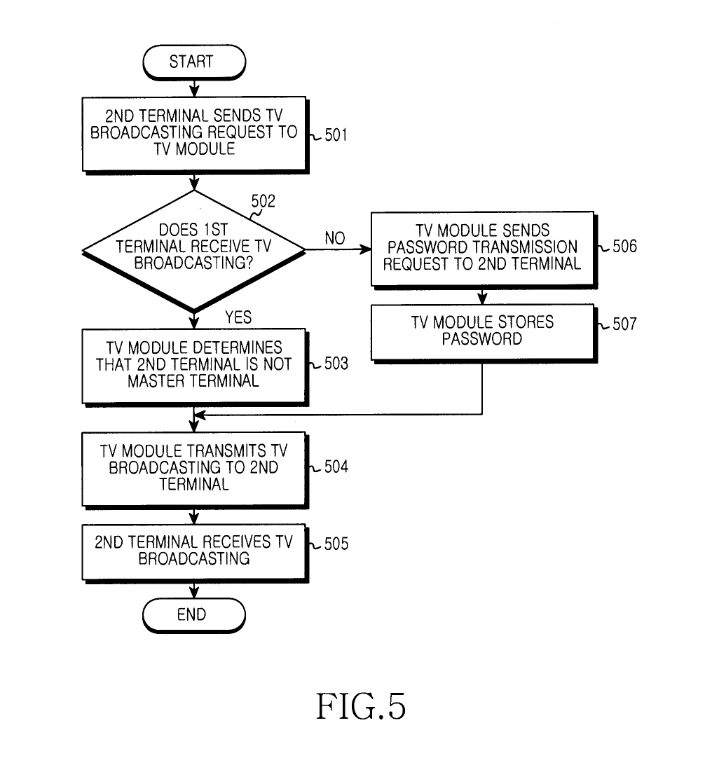

FIG. 5 is a flowchart illustrating a process of receiving TV broadcasting in a 2nd portable terminal in a TV channel sharing method according to an exemplary embodiment of the present invention.

As previously-described with reference to FIG. 4, according to the present, it is assumed that, in a state where a first portable terminal is granted a master authority of switching a TV channel, and a 2nd portable terminal seeks to receive a TV channel that the first portable terminal is receiving. First, in step 501, the 2nd portable terminal sends a TV broadcasting request to a TV module. In step 502, the TV module receiving the TV broadcasting request from the 2nd portable terminal determines if the first portable terminal is continuously receiving TV broadcasting.

If it is determined in step 502 that the first portable terminal is receiving the TV broadcasting, in step 503, the TV module determines that the 2nd portable terminal is not a master terminal Accordingly, there is no need to prompt for a password in order to grant the 2nd portable terminal a master function of switching a TV channel and thus, in step 504, the TV module just transmits the TV broadcasting to the 2nd portable terminal without sending a password transmission request to the 2nd portable terminal After that, in step 505, the 2nd portable terminal receives the TV broadcasting. Next, the process of receiving the TV broadcasting in the 2nd portable terminal is terminated.

In contrast, if it is determined in step 502 that the first portable terminal, which is the portable terminal granted the master function, is not receiving the TV broadcasting, in step 506, the TV module sends a password transmission request to the 2nd portable terminal so as to grant the 2nd portable terminal the master function of switching the TV channel.

In step 507, the 2nd portable terminal receives a password input from a user in a storage area and transmits the password to the TV module, and the TV module stores the received password. Next, aforementioned steps 504 and 505 are repeated and then, the process of receiving the TV broadcasting in the 2nd portable terminal is terminated.

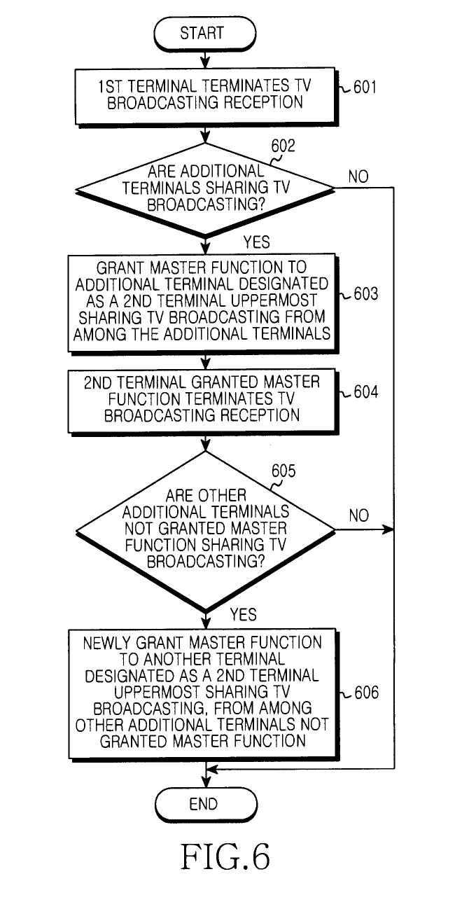

FIG. 6 is a flowchart illustrating exemplary operation of a process of, as a portable terminal granted a master function terminates broadcasting reception, newly (i.e. initially) granting the portable terminal the master function in a TV broadcasting sharing method according to an exemplary embodiment of the present invention.

As illustrated in FIG. 6, in step 601, a first portable terminal receiving TV broadcasting terminates TV broadcasting reception. If so, in step 602, a TV module determines if additional (i.e. other) portable terminal(s) are sharing the TV broadcasting with the first portable terminal. If it is determined in step 602 that the 2nd portable terminals are sharing the TV broadcasting with the first portable terminal, in step 603, the TV module grants a master function to one of the other portable terminals (designated herein as the 2nd portable terminal) uppermost sharing the TV broadcasting, from among the other portable terminals. In other words, in a case where at least one or more other (additional) portable terminals share the same TV channel with the first portable terminal granted the master function, it arranges sequences in which the additional portable terminals share the TV channel according to a sequence of time, and assigns an order of priority to the 2nd portable terminals in the uppermost sequence of sharing.

After that, in step 604, the 2nd portable terminal granted the master function terminates TV broadcasting reception. In response, in step 605, the TV module determines if there are other portable terminals not granted the master function which are sharing the TV broadcasting with the first portable terminal, as in a case where the first portable terminal terminates the TV broadcasting reception. The reason for such a determination is to again grant the master function to another one of the additional portable terminals not previously granted the master function. Thus, such a portable terminal is “newly granted” the master function.

If it is determined in step 605 that the other portable terminals not granted the master function are sharing the TV broadcasting with the first portable terminal, in step 606, the TV module will newly grants the master function to a particular portable terminal which is uppermost sharing the TV broadcasting, from among the other portable terminals not granted the master function. Next, the process according to the present invention is terminated.

With continued reference to FIG. 6, if it is determined in steps 602 and 605 that the 2nd portable terminals have not shared or do not share the TV broadcasting with the first portable terminal, the process according to the present invention can be terminated.

For example, assuming that there are additional portable terminals A, B, and C excepting 1st terminal, and the portable terminals acquire the authority to share the TV broadcasting in the order of A→B→C, in step 603, the portable terminal A is granted as the 2nd portable terminal uppermost sharing the TV broadcasting, and in step 606, the portable terminal B is granted as the 2nd portable terminal uppermost sharing the TV broadcasting.

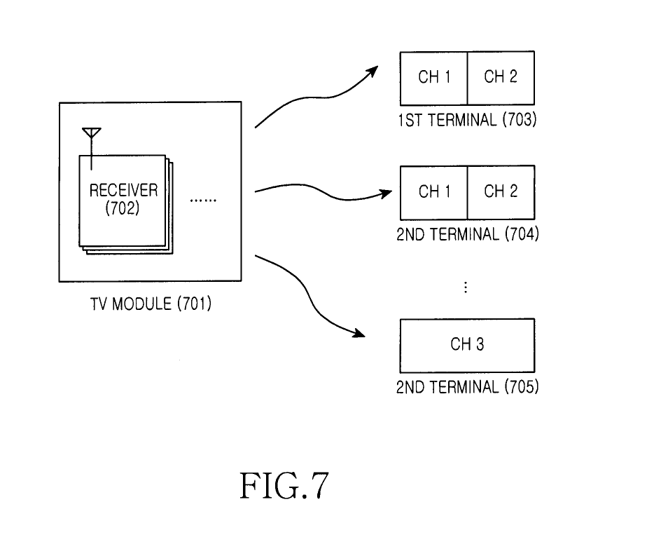

FIG. 7 is a diagram illustrating that, in a state where a first portable terminal is granted a master function, another portable terminal can also be granted the master function in a TV channel sharing method according to an exemplary embodiment of the present invention.

As illustrated in FIG. 7, the number of TV channels that the first and 2nd portable terminals can simultaneously receive is preferably proportional to the number of receivers built in or coupled with a TV module. In, if the number of receivers built in the TV module is four, the number of TV channels that the first and 2nd portable terminals can simultaneously receive is four.

Also, if the first portable terminal is simultaneously receiving TV channels of ‘K’ number from a TV module in which receivers of ‘N’ number are built, the 2nd portable terminal can switch the TV channels of (N-K) number. A detailed description is made with reference to FIG. 7.

FIG. 7 illustrates, for example, that the number of receivers 702 built in a TV module 701 is three. Accordingly, the number of TV channels that first portable terminal 703 and 2nd portable terminals 704, and 705 can simultaneously receive is a maximum of three. Also, FIG. 7 illustrates that the first portable terminal 703 simultaneously receives two channels (i.e., CH 1 and CH 2). Accordingly, regarding CH 1 and CH 2, the first portable terminal 703 is granted a master function of switching a TV channel, and can freely switch the two TV channels (i.e., CH 1 and CH 2) according to the master function. In, regarding CH 3, the first portable terminal 703 is not granted the master function.

Also, the 2nd portable terminals 704 and 705 can simultaneously receive the maximum of three channels in this example. FIG. 7 illustrates that the 2nd portable terminal 704 simultaneously receives two channels (i.e., CH 1 and CH 2). Accordingly, regarding the two channels (i.e., CH 1 and CH 2), the 2nd portable terminal 704 is not granted a master function of switching a TV channel. This is because, regarding CH 1 and CH 2, the first portable terminal 703 has been already granted the master function. However, with regard to CH 3, because the first portable terminal 703 does not receive CH 3, the other 2nd portable terminal 705 receiving CH 3 is granted the master function of switching the TV channel. In other, the portable terminal 705 can switch a TV channel from CH 3 to other channels while viewing CH 3.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed invention.

While the invention has been shown and described with reference to certain preferred embodiments thereof, it will be understood by those skilled in the art that various changes in form and details may be made therein without departing from the spirit and scope of the invention as defined by the appended claims

What is claimed is:

1. A method for sharing Television (TV) broadcasting with a plurality of portable terminals, the method comprising:
by a first portable terminal, connecting to a wireless network, and sending a TV broadcasting request to a TV module to receive a TV broadcast that is converted by the TV module to a protocol compatible with the first portable terminal;
by the first portable terminal, receiving a password input request from the TV module, and transmitting a password to the TV module to be granted a master function for switching a TV channel;
by the first portable terminal, receiving the TV broadcast sent from the TV module through the wireless network; and
by one or more additional portable terminals, receiving the TV broadcast from the TV module through the wireless network, and sharing the TV broadcast with the first portable terminal.

2. The method of claim 1, wherein only the first portable terminal has capability for switching the TV channel in accordance with the master function granted by the TV module.

3. The method of claim 1, further comprising: when the first portable terminal switches a channel of the TV broadcast, simultaneously switching channels in the one or more additional portable terminals sharing the TV broadcast with the first portable terminal

4. The method of claim 1, further comprising: by the TV module, receiving a broadcasting signal from a broadcasting station and transmitting the TV broadcasting to the first and one or more additional portable terminals through the wireless network.

5. The method of claim 1, wherein the TV module converts the broadcasting signal received into a protocol compatible with the first and one or more additional portable terminals over the wireless network.

6. The method of claim 1, further comprising: by the TV module, receiving and storing the password transmitted to the TV module by the first portable terminal

7. The method of claim 1, further comprising:
by the TV module receiving TV broadcasting requests from the one or more additional portable terminals through the wireless network;
by the TV module, determining whether the first portable terminal is receiving the TV broadcast from the TV module; and
by the TV module, transmitting the TV broadcast to the one or more additional portable terminals through the wireless network.

8. The method of claim 7, further comprising:
by the TV module, when the first portable terminal is not receiving the TV broadcast from the TV module, requesting to the one or more additional portable terminals to transmit passwords to the TV module in order to grant the master function to the at least one or more additional portable terminals;
by the TV module, receiving the passwords transmitted from the one or more additional portable terminals and storing the passwords; and
by the TV module, transmitting the TV broadcast to the one or more additional portable terminals through the wireless network.

9. The method of claim 1, further comprising:
by the first portable terminal, terminating receipt of the TV broadcast from the TV module;
by the TV module, determining whether the one or more additional portable terminals are sharing the TV broadcast with the first portable terminal; and
by the TV module, when the one or more additional portable terminals are sharing the TV broadcast, granting the master function to any one of the one or more additional portable terminals.

10. The method of claim 9, wherein granting the master function to any one of the one or more additional portable terminals comprises granting the master function to a particular portable terminal of the one or more additional portable terminals that uppermost shares reception of the TV broadcast, from among a remainder of the one or more additional portable terminals.

11. A system for sharing Television (TV) broadcasting among a plurality of portable terminals, the system comprising:
a TV module that transmits TV broadcasts over a wireless network compatible with the plurality of portable terminals;
a first portable terminal comprising:
a broadcasting unit that couples with the wireless network and sends a TV broadcasting request to the TV module, and receives the TV broadcast from the TV module through the wireless network;
a communication unit that requests the TV module grant to the first portable terminal a master function of switching a TV channel of the received TV broadcast, receives in response to the request a password input request from the TV module, and transmits a password to the TV module; and
one or more additional portable terminals respectively comprising broadcasting units that transmit over the wireless network to a request to receive the TV broadcast from the TV module through the wireless network, and share receipt of the TV broadcast with the first portable terminal.

12. The system of claim 11, further comprising a channel switching unit of the first portable terminal for controlling switching channels received in the one or more additional portable terminals sharing the TV broadcast with the first portable terminal

13. The system of claim 11, wherein the TV module further comprises:
a receiver for receiving a broadcasting signal from a broadcasting station;
a signal modulator for modulating the broadcasting signal forwarded from the receiver, into a wireless network signal; and
a transmitter for transmitting the TV broadcast to the broadcasting units of the first and one or more additional portable terminals through the wireless network.

14. The system of claim 11, wherein the TV module further comprises a storage unit for storing the password.

15. The system of claim 11, wherein the TV module comprises a determination unit for determining if the first portable terminal is receiving the TV broadcast from the TV module, and
if the first portable terminal is receiving the TV broadcast from the TV module, the transmitter transmits the TV broadcast to the one or more additional portable terminals through the wireless network without providing a master function to the one or more additional portable terminals.

16. The system of claim 15, wherein, if the first portable terminal is not receiving the TV broadcast, the determination unit requests the one or more additional portable terminals to transmit passwords to the TV module in order to grant the master function to one of the one or more portable terminals, and
the transmitter transmits the TV broadcast to the one or more additional portable terminals through the wireless network and the determination unit designates that one of the one or more additional portable terminals receive the master function according to predetermined criteria.

17. The system of claim 11, wherein when the first portable terminal terminates the TV broadcasting reception, a determination unit of the TV module determines whether any of the one or more additional portable terminals are sharing the TV broadcast with the first portable terminal, and
if any of the one or more portable terminals are sharing the TV broadcast, granting the master function to a particular one of the one or more additional portable terminals.

18. The system of claim 17, wherein the determination unit for granting the master function to any one of the one or more additional portable terminals grants the master function to the particular portable terminal with an uppermost sharing of the TV broadcasting, from among all the one or more additional portable terminals.

19. A first portable terminal that shares reception of a television (TV) broadcast over a wireless network and controls a switching function of TV channels received from a TV module for at least one or more additional portable terminals sharing receipt of the broadcast with the first portable terminal, comprising:
a broadcasting unit that couples with the wireless network and sends a TV broadcasting request to a TV module, and receives the requested TV broadcast from the TV module through the wireless network;
a communication unit that requests the TV module grant a master function of switching a TV channel of the received TV broadcast, receives in response to the request a password input request from the TV module, and transmits a password to the TV module; and
wherein a control of the switching of the TV channel being broadcast by the TV module is controlled by the master function granted to the first portable terminal for both the first portable terminal and for said at least one or more additional portable terminals sharing receipt of the broadcast with the first portable terminal.
